(19) United States
(12) Patent Application Publication
(10) Pub. No.: US 2015/0142248 A1
(43) Pub. Date: May 21, 2015

(54) APPARATUS AND METHOD FOR PROVIDING LOCATION AND HEADING INFORMATION OF AUTONOMOUS DRIVING VEHICLE ON ROAD WITHIN HOUSING COMPLEX

(71) Applicant: ELECTRONICS AND TELECOMMUNICATIONS RESEARCH INSTITUTE, Daejeon-city (KR)

(72) Inventors: Seung-Jun HAN, Daejeon (KR); Kyung-Bok SUNG, Daejeon (KR); Kyoung-Wook MIN, Sejong (KR); Jeong-Dan CHOI, Daejeon (KR)

(21) Appl. No.: 14/519,288

(22) Filed: Oct. 21, 2014

(30) Foreign Application Priority Data
Nov. 20, 2013 (KR) 10-2013-0141113

(51) Int. Cl. G01C 21/36

(52) U.S. Cl. CPC G01C 21/3602
USPC 701/23

(57) ABSTRACT

Disclosed herein is an apparatus and method for providing location and heading information of an autonomous driving vehicle on a road within a housing complex. The apparatus includes an image sensor installed on an autonomous driving vehicle and configured to detect images of surroundings depending on motion of the autonomous driving vehicle. A wireless communication unit is installed on the autonomous driving vehicle and is configured to receive a Geographic Information System (GIS) map of inside of a housing complex transmitted from an in-housing complex management device in a wireless manner. A location/heading recognition unit is installed on the autonomous driving vehicle, and is configured to recognize location and heading of the autonomous driving vehicle based on the image information received from the image sensor and the GIS map of the inside of the housing complex received via the wireless communication unit.

### CROSS REFERENCE TO RELATED APPLICATION

This application claims the benefit of Korean Patent Application No. 10-2013-0141113, filed Nov. 20, 2013, which is hereby incorporated by reference in its entirety into this application.

### BACKGROUND OF THE INVENTION

1. Technical Field

The present invention relates generally to an apparatus and method for providing the location and heading information of an autonomous driving vehicle on a road within a housing complex and, more particularly, to an apparatus and method for estimating and providing the location and heading of the autonomous driving vehicle so as to drive and park the corresponding vehicle on a road within a housing complex.

2. Description of the Related Art

Generally, when an autonomous driving vehicle is traveling, a road within a housing complex is the source or destination of a passenger, and thus a driving action and a parking action simultaneously occur. Therefore, more precise measurement of the location and heading of an autonomous driving vehicle on the road within a housing complex than those required on a normal road is required.

However, on the road within a housing complex, the precision of the location information provided by a Global Positioning System (GPS) is greatly deteriorated, or an underground shadow region occasionally occurs, due to the presence of buildings or facilities. Furthermore, there are typically discontinuous roads (traffic lanes), further making it difficult to estimate the location of a vehicle using only a method of tracking a traffic lane or a map-matching method.

In other words, the performance of expensive GPS/Inertial Measurement Unit (IMU) equipment installed in most existing autonomous driving vehicles, as well as a typical GPS, is also greatly deteriorated when numerous complex buildings are clustered close together or when underground areas are successively present.

Therefore, in existing research into autonomous driving vehicles, expensive equipment such as an omni-directional three-dimensional (3D) laser scanner, as well as GPS/IMU equipment, has been used so as to collect precise location and heading information of a vehicle. Further, by means of such equipment, a large-capacity and a high-precision map, such as a probability map or a grid map, is created in advance, and then location recognition technology using such a map has been used.

However, such an approach may cause the following problems.

First, the use of an expensive sensor and large-capacity data becomes the cause of increasing system costs. This will be a serious obstacle to the popularization of autonomous driving vehicles in the future.

Second, a system in which an autonomous driving vehicle independently contains a precision map of a road within a housing complex may cause a difference between the map and an actual situation. This makes it difficult for the map previously contained in the autonomous driving vehicle to reflect actual changes in real time. Further, in the case of a specific housing complex, there may occur a case where no autonomous driving vehicle can have such map information in advance due to security issues. Such a difference between the map of the road within a housing complex and the actual situation within the housing complex may prevent autonomous driving vehicles from traveling due to the characteristics of the road within the housing complex in which a traffic lane is discontinuous and the road connects with a parking lot area, unlike a normal road that enables the traveling of the vehicles using map-matching technology such as tracking the lane of a road.

Third, since an existing map used to measure locations in the past is a map having information dependent on sensors, it is very difficult to mutually utilize pieces of heterogeneous equipment, and thus maps suitable for respective systems must be separately created. For example, when a laser sensor is used, a map must have information about the distance, angle and intensity of laser beams. Further, when an image sensor is used, the map must have the feature information of images. Therefore, in practice, separate maps based upon and displaying different types of information must be created.

Finally, when all autonomous driving vehicles radiate laser or radar beams in all directions in order to recognize surrounding environments, a large number of laser beams or radar waves radiated from a concentrated space may have a possibility of mutually interfering with each other or directly/indirectly injure pedestrians.

As related preceding technology, Korean Patent No. 0520166 (entitled “Apparatus and method for detecting the location of a moving object using a navigation system”) discloses technology for correcting sensor information including errors in real time whenever sensor information is input by utilizing a restriction model using map information, thus improving the precision of determination of a vehicle location.

As another related preceding technology, Korean Patent No. 1134270 (entitled “Vehicle-mounted device for detecting a travel path”) discloses technology in which a corrected location is obtained by correcting a recently estimated location using a correction vector obtained based on a previously estimated location and a map-matching location, so that an error in the corrected location is minimized, and the precision of a map-matching location obtained by performing map-matching processing on the corrected location having the minimized error is improved, thus precisely determining the travel path of a vehicle.

As further related preceding technology, Korean Patent No. 1177374 (entitled “Vehicle location estimation method using an interactive multi-model filter”) discloses technology for merging GPS location information with the information of in-vehicle sensors and estimating the location of a vehicle, thus stably estimating the location of the vehicle even in a place where the reception of GPS location information is bad.

### SUMMARY OF THE INVENTION

Accordingly, the present invention has been made keeping in mind the above problems occurring in the prior art, and an object of the present invention is to provide an apparatus and method that recognize and provide the precise location and heading of an autonomous driving vehicle on a road within a complicated housing complex using only a standardized Geographic Information System (GIS) map and image information.

In accordance with an aspect of the present invention to accomplish the above object, there is provided an apparatus for providing location and heading information of an autonomous driving vehicle on a road within a housing complex, including an image sensor installed on an autonomous driving vehicle and configured to detect images of surroundings depending on motion of the autonomous driving vehicle; a wireless communication unit installed on the autonomous driving vehicle and configured to receive a Geographic Information System (GIS) map of inside of a housing complex transmitted from an in-housing complex management device in a wireless manner; and a location/heading recognition unit installed on the autonomous driving vehicle, and configured to recognize location and heading of the autonomous driving vehicle based on the image information received from the image sensor and the GIS map of the inside of the housing complex received via the wireless communication unit.

The location/heading recognition unit may estimate ego-motion from stereoscopic images, acquired by the image sensor, using a multi-view image processing technique, convert the images collected by the image sensor into images projected onto a ground surface of the road to extract markers on the road, obtain a probability of matching the GIS map to estimate a current location and attitude, and estimate a dynamic behavioral state of the vehicle based on the estimated ego-motion and the estimated current location and attitude to output predicted results of a state of the vehicle.

The location/heading recognition unit may be configured to define three-dimensional (3D) coordinates of feature points detected from an image initially acquired by the image sensor as initial values of a point cloud, and track feature points acquired from a previous key frame on an image plane whenever each image is input from the image sensor, obtain relative coordinates at a current time based on a key frame using a Perspective-Three-Point (P3P) technique, and calculate the ego-motion from relative coordinates of the previous key frame and relative coordinates at the current time.

The location/heading recognition unit may be configured such that, when movement of the autonomous driving vehicle above a predetermined amount occurs, and generation of a new key frame is required, a separate thread performs bundle adjustment and then updates the point cloud.

The location/heading recognition unit may use a combination of a Particle Filter (PF) with an Extended Kalman Filter (EKF) to compare each projected image with the GIS map.

The location/heading recognition unit may use a linear Kalman filter upon estimating the dynamic behavioral state of the corresponding vehicle.

The wireless communication unit may additionally receive path information including a recommended path from the in-housing complex management device, and transmit the path information to the location/heading recognition unit.

The recommended path may include a path along which the vehicle arrives at a destination, and a path along which the vehicle departs from the housing complex.

The wireless communication unit may additionally receive auxiliary information with respect to interference with safe driving of the autonomous driving vehicle from the in-housing complex management device, and transmit the auxiliary information to the location/heading recognition unit.

The image sensor may include a plurality of sensors.

In accordance with another aspect of the present invention to accomplish the above object, there is provided a system for providing location and heading information of an autonomous driving vehicle on a road within a housing complex, including an in-housing complex management device including an environment monitoring sensor for monitoring entry of an approved vehicle into a housing complex, and a management server for, as the entry of the approved vehicle into the housing complex is monitored by the environment monitoring sensor, generating a GIS map of inside of the housing complex and transmitting the GIS map to an in-autonomous driving vehicle device in a wireless manner; and the in-autonomous driving vehicle device including an image sensor for detecting images of surroundings depending on motion of the autonomous driving vehicle, and a location/heading recognition unit for recognizing location and heading of the autonomous driving vehicle, based on the GIS map of the inside of the housing complex transmitted in a wireless manner from the in-housing complex management device and image information transmitted from the image sensor.

In accordance with a further aspect of the present invention to accomplish the above object, there is provided a method for providing location and heading information of an autonomous driving vehicle on a road within a housing complex, including detecting, by an image sensor installed on an autonomous driving vehicle, images of surroundings depending on motion of the autonomous driving vehicle; receiving, by a wireless communication unit installed on the autonomous driving vehicle, a Geographic Information System (GIS) map of inside of the housing complex transmitted from an in-housing complex management device in a wireless manner; and recognizing, by a location/heading recognition unit installed on the autonomous driving vehicle, location and heading of the autonomous driving vehicle based on image information about the detected images and the received GIS map of the inside of the housing complex.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing a system to which the present invention is applied;

FIG. 2 is a diagram showing an information transmission procedure between an in-housing complex management device and an in-unmanned vehicle device shown in FIG. 1;

FIG. 3 is a diagram showing an example of information provided by the in-housing complex management device shown in FIG. 1;

FIGS. 4A and 4B are diagrams showing an example of the installation of an image sensor shown in FIG. 1;

FIG. 5 is a flowchart schematically showing a method of estimating the location and heading of a vehicle according to an embodiment of the present invention;

FIG. 6 is a diagram showing procedures performed at respective steps of FIG. 5 over time;

FIG. 7 is a diagram employed in the description of an ego-motion estimation procedure shown in FIG. 5;

FIG. 8 is a flowchart showing in detail the ego-motion estimation procedure shown in FIG. 5;

FIG. 9 is a flowchart showing in detail the location/attitude estimation procedure shown in FIG. 5; and

FIGS. 10 to 12 are diagrams employed in the description of FIG. 9.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

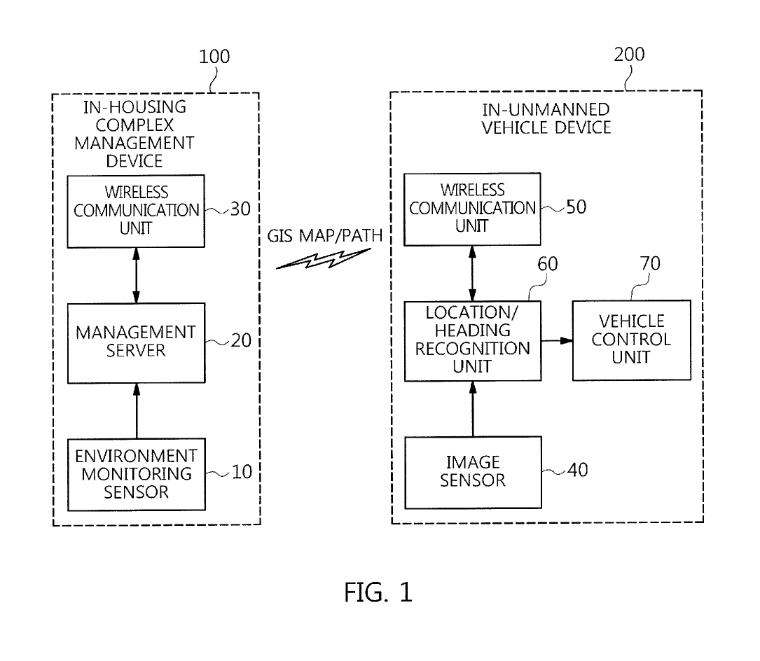

FIG. 1 is a configuration diagram showing a system to which the present invention is applied.

The system to which the present invention is applied includes a management device 100 in a housing complex (hereinafter referred to as an “in-housing complex management device 100”) and a device 200 in an unmanned vehicle (hereinafter referred to as an “in-unmanned vehicle device 200”).

The in-housing complex management device 100 includes an environment monitoring sensor 10, a management server 20, and a wireless communication unit 30.

The environment monitoring sensor 10 monitors the entry of approved vehicles into the housing complex. The environment monitoring sensor 10 monitors the states of vehicles parked in a parking lot, obstacles, pedestrians, a vehicle driving restriction section, etc. The environment monitoring sensor 10 is installed in a plurality of places within the housing complex. The environment monitoring sensor 10 transmits the resulting signals of monitoring to the management server 20.

The management server 20 generates a GIS map of the inside of the housing complex and a required path when the entry of an approved vehicle into the housing complex is monitored by the environment monitoring sensor 10. Here, the required path includes a path along which the vehicle arrives at a destination, and a path along which the vehicle departs from the housing complex.

The wireless communication unit 30 sends the GIS map of the inside of the housing complex and the path, from the management server 20, to the in-unmanned vehicle device 200 in a wireless manner.

The in-unmanned vehicle device 200 includes an image sensor 40, a wireless communication unit 50, a location/heading recognition unit 60, and a vehicle control unit 70.

The image sensor 40 is installed in the corresponding autonomous driving vehicle and is configured to detect images of the surroundings of the corresponding vehicle depending on the movement of the vehicle. A detailed description of the image sensor 40 will be made later.

The wireless communication unit 50 performs wireless communication with the wireless communication unit 30 of the in-housing complex management device 100. The wireless communication unit 50 receives the GIS map of the inside of the housing complex and the path, which are transmitted in a wireless manner from the wireless communication unit 30, and transfers the GIS map and the path to the location/heading recognition unit 60.

The location/heading recognition unit 60 recognizes (calculates) the location and heading of its own vehicle based on the image information from the image sensor 40 and the GIS map from the wireless communication unit 50. The location/heading recognition unit 60 transmits the results of recognition to the vehicle control unit 70.

The vehicle control unit 70 performs required control for its own vehicle based on the output information of the location/heading recognition unit 60.

That is, the unmanned vehicle (autonomous driving vehicle) performs required driving and parking using the GIS map of the inside of the housing complex and the path which are obtained via wireless communication and the image information which is independently collected by the vehicle itself. In this case, the corresponding vehicle calculates its own precise location and heading using only the GIS map and the image information, and the vehicle control unit 70 of the corresponding vehicle performs vehicle control based on the calculated location and heading. Here, details related to the vehicle control are excluded from the scope of the present invention, and thus a description thereof will be omitted.

The reasons for using the GIS map and the image information in the present invention are given as follows. A standardized GIS map may be easily generated and managed, may be easily exchanged among heterogeneous systems thanks to standardized information, and may be configured using a relatively very small amount of data. Therefore, the GIS map may be easily managed within each facility. Further, since an image sensor has a relatively very low price and is a passive sensor, it is a safe information collection means which does not interfere with other sensors, and causes no danger of usage, as in the case of an active sensor such as a laser or radar device.

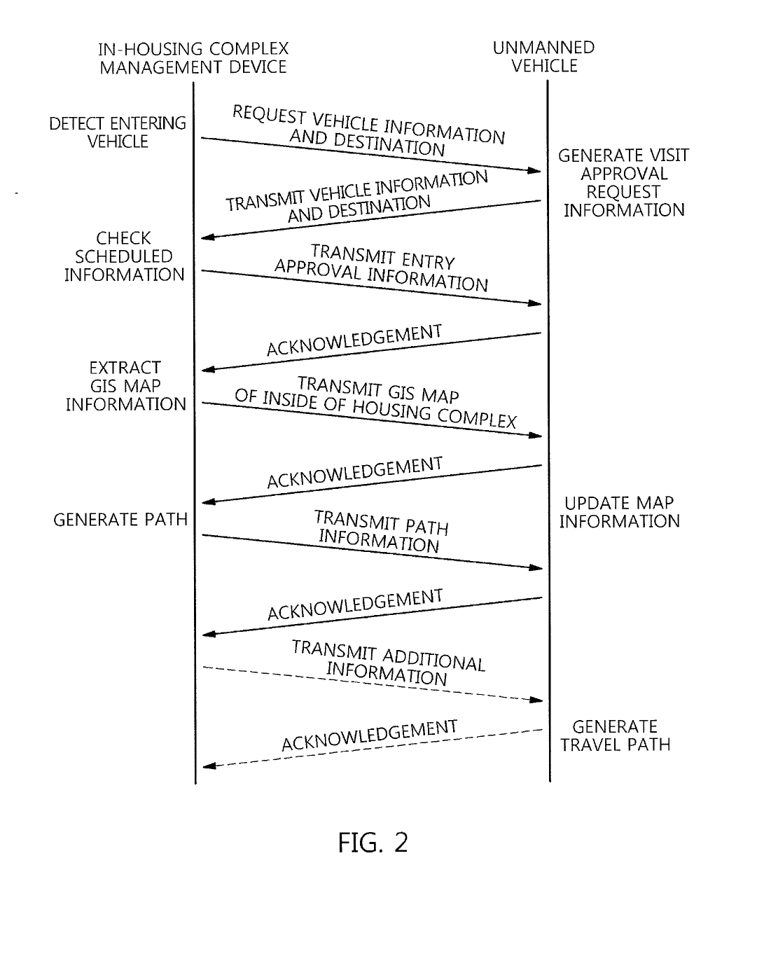

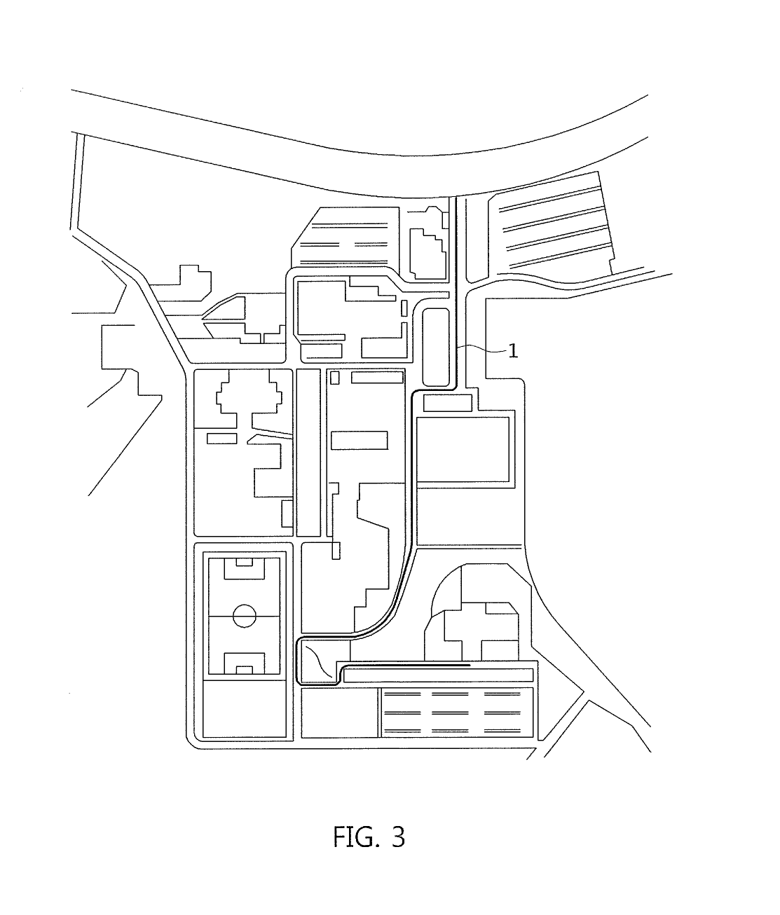

FIG. 2 is a diagram showing an information transmission procedure between the in-housing complex management device and the in-unmanned vehicle device shown in FIG. 1, and FIG. 3 is a diagram showing an example of information provided by the in-housing complex management device shown in FIG. 1.

When an autonomous driving vehicle visits a housing complex, the in-housing complex management device 100 detects a target vehicle, and requests information required to identify the vehicle (e.g., vehicle information, a destination, etc.).

The corresponding target vehicle (that is, the autonomous driving vehicle that visits the housing complex) transmits the purpose of the visit, the destination, etc. to the in-housing complex management device 100.

The in-housing complex management device 100 determines whether to approve the entry of the vehicle into the housing complex (e.g., determination based on the checking of scheduled information or the like), and transmits entry approval information to the target vehicle to notify the target vehicle of the approval of entry while providing relevant information to the target vehicle. Here, the relevant information provided by the in-housing complex management device 100 to the target vehicle includes GIS map information of the inside of the housing complex, a recommended path to the destination of the target vehicle, and additional safe driving information depending on the circumstances.

The GIS map of the inside of the in-housing complex is the most important core information provided by the in-housing complex management device 100. The GIS map of the inside of the in-housing complex is implemented using a numerical map other than a probability map or a grid map used by existing autonomous driving vehicles, mobile robots, or the like. The numerical map is a map for generally representing topographic information by data having a vector or raster format. The present invention enables a map having a very small amount of data and having high precision to be configured by exploiting only vector information. The numerical map includes information such as a traffic lane, a parking line, road markers, a parking space, and a vehicle drivable space, and includes vector information and attribute information of each item. Here, the vehicle drivable space includes a normal road and a parking lot, which is an area other than the road, and is represented by a polygonal or polyline shape. Further, in order to indicate the characteristics of each space, the space includes attribute information such as a node link.

The recommended path denotes auxiliary information for the safe driving of the target vehicle, and presents a preferable travel path indicated by reference numeral “1”) to the destination of the target vehicle (at which the target vehicle has arrived. The travel path 1 is a path recommended by the in-housing complex management device 100, and is generated by the management server 20 in consideration of areas in which pedestrians frequently appear and a possibility of causing accidents is present, or areas to be bypassed or the like for other security or safety reasons, and is then provided to the corresponding target vehicle.

In addition, the in-housing complex management device 100 may provide auxiliary information with respect to potential sources of interference with the safe driving of the vehicle, such as obstacles and temporarily inaccessible areas. When the occurrence of a static or dynamic obstacle that may interfere with the driving of the vehicle is detected by the environment monitoring sensor 10, this detected information is reported to the management server 20, and the management server 20 provides the information to the target vehicle if necessary. Further, information about regions in which the driving of a vehicle is temporarily restricted due to the causes of constructions, registered by a manager, and safety or security reasons may be provided together with the above information.

Accordingly, the target vehicle plans a path along which it will travel, based on the provided information, determines a path in consideration of the information of the environment monitoring sensor 10 if necessary, and safely travels to a final destination along the path.

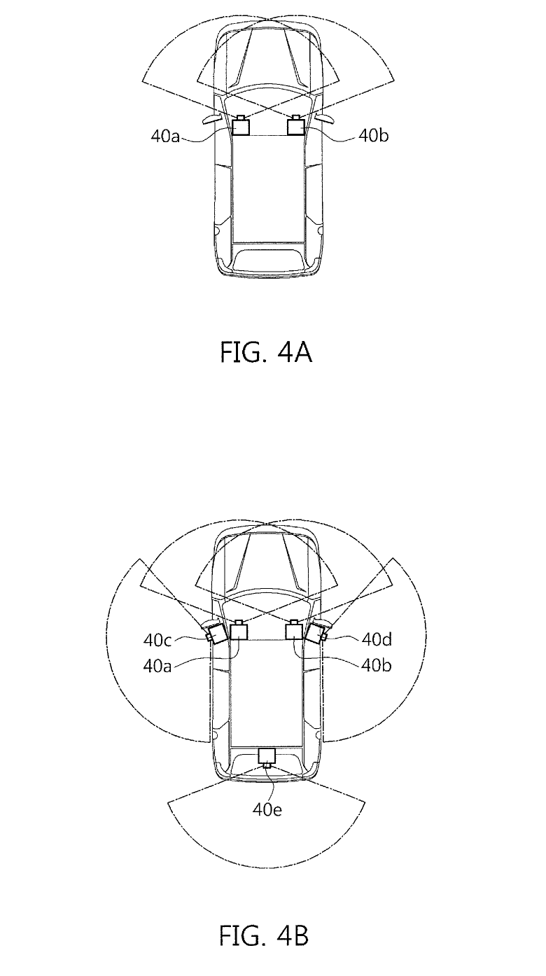

FIGS. 4A and 4B are diagrams showing an example of the installation of image sensors shown in FIG. 1.

In order to implement the present invention, at least two forward cameras 40a and 40b (image sensor 40) are required, as shown in FIG. 4A. In addition, as shown in FIG. 4B, a plurality of auxiliary cameras 40c, 40d, and 40e may be used.

Images captured (collected) by the two forward cameras 40a and 40b are transmitted to the location/heading recognition unit 60. The location/heading recognition unit 60 may combine those images in a stereoscopic manner to estimate the movement of the vehicle, and may compare images projected onto a ground surface with GIS map data to estimate the location and heading of its own vehicle. In this case, when the auxiliary cameras 40c, 40d, and 40e may be additionally used, the range of detection of the projected images may become wider, thus further improving precision and robustness.

Further, these cameras 40a, 40b, 40c, 40d, and 40e must be synchronized with each other, and may be utilized for multiple purposes, such as blind spot monitoring, a rearward camera function, and a forward monitoring (around view monitoring) system, depending on the locations of installation.

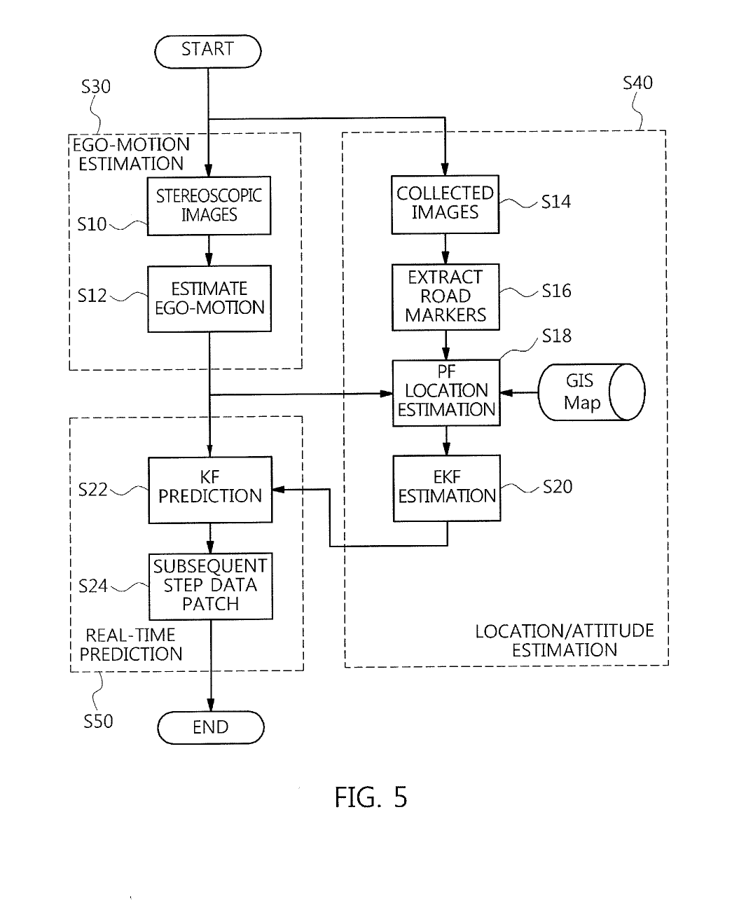

FIG. 5 is a flowchart showing schematically showing a method for estimating the location and heading of a vehicle according to an embodiment of the present invention.

The schematic method for estimating the location and heading of the vehicle according to the present invention may be chiefly divided into ego-motion estimation procedure S30, location and attitude estimation procedure S40, and real-time prediction procedure S50.

First, when the ego-motion estimation procedure S30 is described, two cameras 40a and 40b (image sensor 40) installed on a front portion of an autonomous driving vehicle acquire stereoscopic images of a forward situation. The acquired stereoscopic images are transferred to the location/heading recognition unit 60 at step S10. Then, the location/heading recognition unit 60 estimates the ego-motion of the vehicle using a multi-view image processing technique from the received stereoscopic images at step S12.

During the performance of the above-described ego-motion estimation procedure S30, the location and attitude estimation procedure S40 is simultaneously performed. In the location and attitude estimation procedure S40, the location/heading recognition unit 60 converts images collected by respective cameras into images projected onto the ground surface of the road at step S14. Then, the location/heading recognition unit 60 extracts markers on the road from the images projected onto the ground surface of the road at step S16. Thereafter, the location/heading recognition unit 60 estimates the current location and attitude of the vehicle by obtaining the probability of matching the GIS map at steps S18 and S20. In this case, as projected images, only a single camera image may be used, but a plurality of camera images may preferably be simultaneously used because it is better to obtain projected images from an area that is as wide as possible so as to improve precision and robustness. At this step, as a tool for comparing the GIS map with image information, a Particle Filter (PF) and an Extended Kalman Filter (EKF) are combined and used.

Finally, at the real-time prediction procedure S50, prediction is performed so as to improve the precision of time at which data is provided. That is, at the vehicle location and attitude estimation procedure S40, a lot of computation time is required, and thus the collected data becomes past (previous) data at the time at which the results of comparison are output. Further, the time of the location and heading information required by the vehicle control unit 70 is not exactly identical to the time of image acquisition. For this, the dynamic behavioral state of the vehicle is estimated using a linear Kalman Filter (KF) based upon the estimated information, and the results of prediction at the exact time requested by the vehicle control unit 70 are provided at steps S22 and S24.

The location and attitude of the vehicle obtained using the above method conform to an orthogonal coordinate system based on the GIS map, and occasionally need to be converted into alternative forms requested by a controller (the vehicle control unit 70) depending on the circumstances. For example, the location and attitude of the vehicle in the orthogonal coordinate system are preferably converted into latitude/longitude coordinates and heading which are universally used, respectively. Since all GIS maps specify coordinate systems used thereby, the location and attitude data may be easily converted into data in a requested coordinate system from the specified coordinate systems.

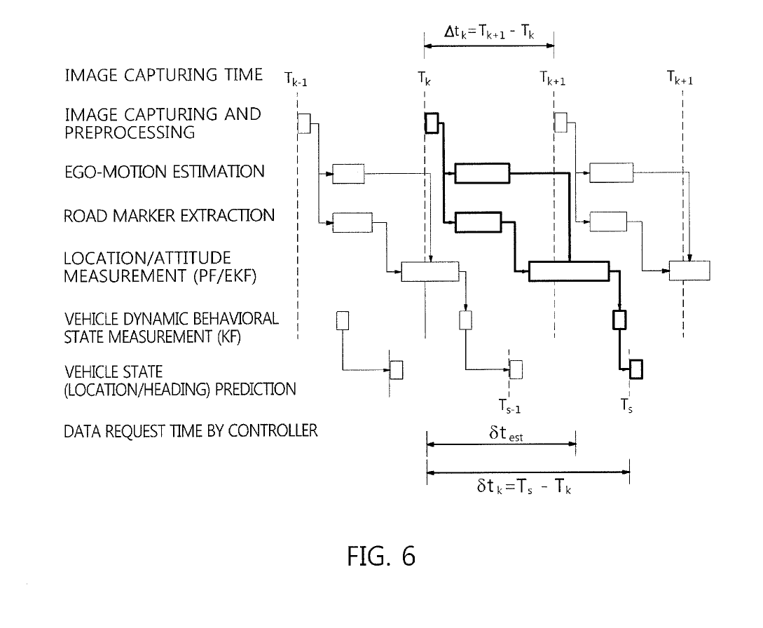

FIG. 6 is a diagram showing procedures performed at respective steps of FIG. 5 over time. In order to process the respective steps shown in FIG. 5 in real time, a method for performing the respective steps will be described from the standpoint of time in FIG. 6.

First, it is assumed that all cameras are synchronized with each other to be capable of simultaneously capturing images for each Δt, and that a processing device, that is, the location/heading recognition unit 60, has a plurality of processor cores to enable multi-threading.

When images are acquired from the cameras at time Tₖ, an ego-motion estimating procedure, the results of which are used as the input of a subsequent estimation procedure, and a road marker extraction procedure, the results of which are used as the input of a Particle Filter (PF), are simultaneously performed.

When the results of the respective procedures (that is, the results of ego-motion estimation and the results of road marker extraction) are derived, the location and attitude of the vehicle are estimated by combining the PF and the EKF which use the results as the inputs thereof. The computation time required for location and attitude estimation is highly variable and requires the longest time depending on the number of particles and the number of pieces of observable data. However, due to the estimation of the dynamic behavioral state of the vehicle performed immediately after the location and attitude estimation, the state of the vehicle at any time may be predicted. Therefore, since the vehicle state prediction procedure needs only to be completed immediately until the ego-motion estimation and road marker extraction steps for a subsequent frame are terminated, sufficient computation time required for the location and attitude estimation step can be secured.

The estimation of the dynamic behavioral state of the vehicle enables the accurate prediction of vehicle state data to be performed for any time δt with respect to time Tₖ, and thus the problem of timing and synchronization of data may be easily solved.

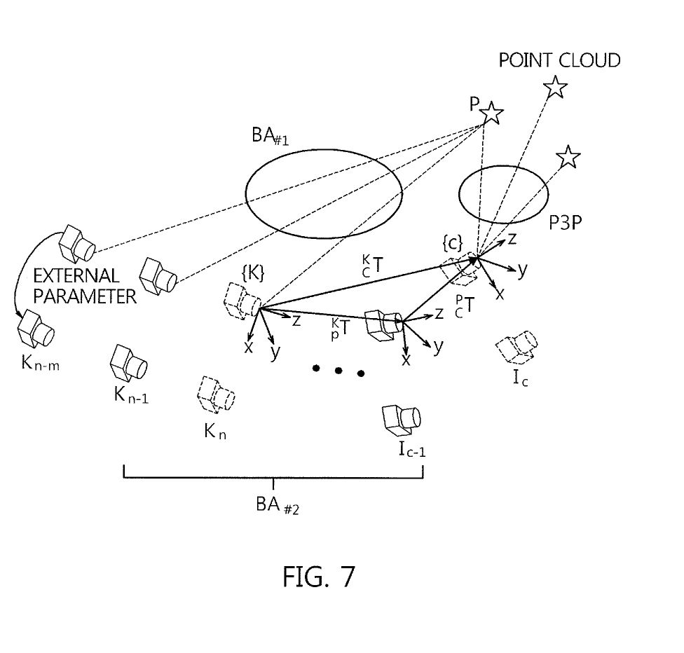

FIG. 7 is a diagram employed in the description of the ego-motion estimation procedure shown in FIG. 5.

The estimation of ego-motion of a vehicle denotes technology for estimating how an object is moving for itself, and refers to, in the present invention, the motion of cameras obtained from a variation between the images of a previous frame and a current frame. Various methods for ego-motion estimation are known to the art and, among these methods, a bundle adjustment method for obtaining optimal parameters for a plurality of images is known as the most accurate method. However, bundle adjustment is disadvantageous in that a computational load is increased, thus making it difficult to perform real-time processing.

In the present invention, a combination of a bundle adjustment method for obtaining optimal 3D coordinates and a Perspective-Three-Point (P3P) method for obtaining the attitude of a camera from the relationship of the projection of the 3D coordinates onto an image plane is used so as to secure precision and real-time properties.

For the description of this procedure, if it is assumed that a key frame is generated whenever the camera is moved by a specific displacement, the coordinate system of an image I_{c} at a current time is defined as {C}, the coordinate system of a most recent key frame Kₙ is defined as {K}, and the coordinate system of an image I_{c-1} in a previous frame is defined as {P}.

First, optimal solutions of the 3D coordinates of feature points based on the coordinate system {K} are obtained via bundle adjustment from m previous key frames. In this case, a set of the 3D coordinates is called a point cloud. Thereafter, solutions of P3P for searching for points at which the 3D coordinates are projected onto a 2D image plane are obtained, and thus a transformation matrix _{C}^{K}T from the coordinate system {K} of the key frames into the coordinate system {C} at the current time may be obtained.

The transformation matrix _{C}^{K}T is changed to _{P}^{K}T, which is the transformation matrix of the previous key frame, in a subsequent key frame. A final transformation matrix _{C}^{P}T indicative of ego-motion which is a relationship of transformation between the key frames may be consequently obtained from the two transformation matrices. If the transformation matrix _{C}^{P}T is represented by an equation, it is given by the following equation:

$${}_{C}^{P} T = [ \begin{matrix}{}_{C}^{P} R & {}_{}^{p}{P}{}_{CORG}^{} \\ 000 & 1\end{matrix} ] = {}_{P}^{K}{T}{}_{}^{- 1} {}_{C}^{K} T$$

where _{C}^{P}R denotes a rotation matrix transformed from the previous key frame into the current key frame, and indicates a variation in the attitude of the vehicle. ^{p}P_{CORG} denotes a motion vector from the previous key frame to the current key frame. Further, an inverse matrix _{P}^{K}T⁻¹ may be simply obtained using the following equation:

$${}_{P}^{K}{T}{}_{}^{- 1} = {}_{K}^{P} T = [ \begin{matrix}{}_{P}^{K}{R}{}_{}^{T} & - {}_{P}^{K}{R}{}_{}^{TK} {P}_{PORG} \\ 000 & 1\end{matrix} ]$$

where _{P}^{K}R denotes a rotation matrix from the coordinate system {K} of the key frame to the coordinate system {P} of a previous key frame, and ^{K}P_{PORG} denotes a motion vector from the coordinate system {K} to the origin of the coordinate system {P}.

In this case, if the image at the current time has reached the condition of a subsequent key frame and new bundle adjustment needs to be performed (BA_{#2}), the corresponding bundle adjustment is performed by an additional thread. Until the completion of this performance, the key frame generated via previous bundle adjustment (BA_{#1}) is maintained, thus preventing the bottleneck of processing from occurring. A method proposed in the present invention does not need to perform bundle adjustment requiring a lot of computations for each frame, and obtains P3P solutions enabling fast computations for each frame, thus realizing high-speed processing. Further, the method of the present invention obtains high-precision 3D coordinates via bundle adjustment performed for each key frame, thus expecting high precision of processing.

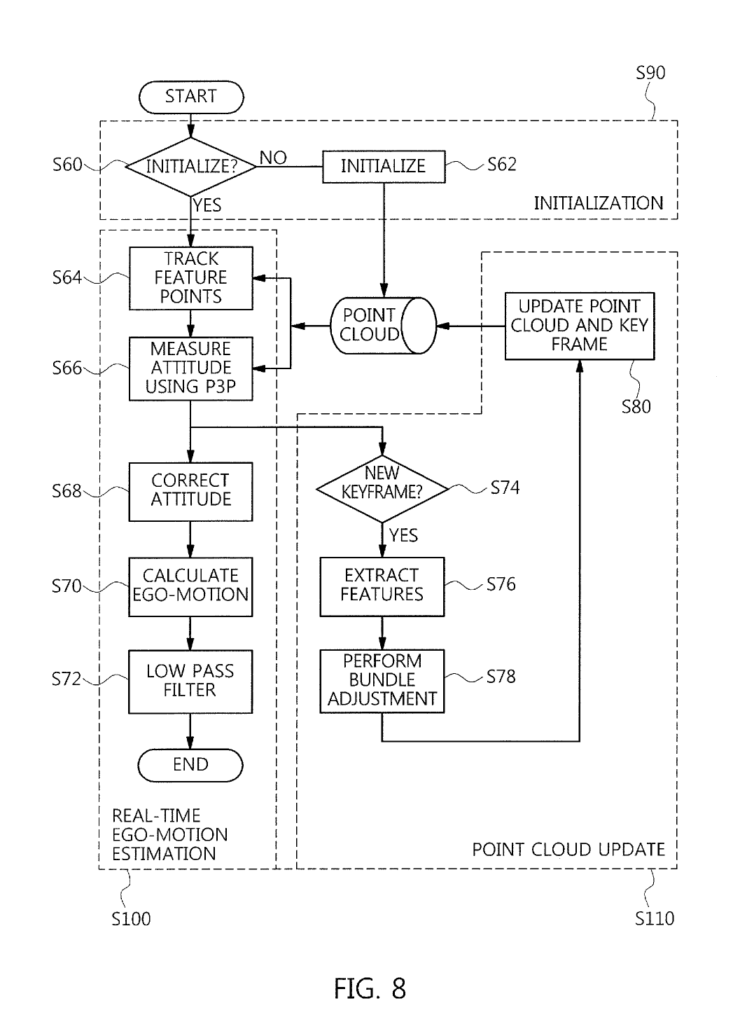

FIG. 8 is a flowchart showing in detail the ego-motion estimation procedure S30 shown in FIG. 5.

The ego-motion estimation step S30 may be chiefly divided into initialization step S90, real-time ego-motion estimation step S100, and point cloud update step S110.

First, the initialization step S90 is performed such that a pair of images, initially acquired from two calibrated forward cameras in an initial state, are defined as key frames, and such that feature points are detected from the respective images. 3D coordinates are obtained from a disparity occurring upon matching left and right images with each other. A disparity d between stereoscopic images for any one point is represented by d=xᵣ−xₗ=bf/Z based on camera models, where xᵣ and xₗ denote coordinates of right and left cameras, b denotes a distance (baseline) between the two cameras, f denotes a focal length, and Z denotes a distance from an optical center point. From the above equation, the coordinates of the respective feature points in a 3D space are obtained by the following equation:

$$[ \begin{matrix}sX \\ sY \\ sZ \\ s\end{matrix} ] = [ \begin{matrix}1 & 0 & 0 & - {c}_{x} \\ 0 & 1 & 0 & - {c}_{y} \\ 0 & 0 & 0 & 1 / f \\ 0 & 0 & 1 / f & 0\end{matrix} ] [ \begin{matrix}{x}_{l} \\ {y}_{l} \\ d \\ 1\end{matrix} ]$$

where X, Y, and X denote coordinate values in the 3D space, s denotes a scale factor, cₓ and c_{y} denote optical center points of images, xₗ denotes the coordinate value of the left camera in an X axis direction, and yₗ denotes the coordinate value of the left camera in a y axis direction.

The 3D coordinates of the feature points obtained in this way are defined as initial values of the point cloud at steps S60 and S62. Although those initial values are values before bundle adjustment is performed and the precision thereof is slightly low, high-precision 3D coordinate values may be obtained via bundle adjustment if the vehicle is moved and a plurality of key frames are generated.

Meanwhile, at real-time ego-motion estimation step S100, feature points obtained from previous key frames are tracked on the image plane whenever each image is input at step S64, and relative coordinates at the current time based on the key frames are obtained using P3P at step S66. Further, the ego-motion of the vehicle is calculated from the relative coordinates of the previous key frames and the relative coordinates at the current time.

P3P is the problem defining a relationship of the projection of 3D coordinates in the point cloud onto 2D coordinates on the image plane. If this is represented by an equation, a projection matrix P indicating a relationship of the projection of 3D coordinates onto 2D coordinates is defined by the following projection equation:

x=PX=K[R|t]X

where x denotes 2D coordinates, X denotes 3D coordinates, K denotes the parameter matrix of a camera, R denotes the rotation matrix of the camera, and t denotes the motion vector of the camera.

When the camera parameter matrix K is given, and three 3D coordinates X are given, the P3P problem is to obtain [R|t] if the three 3D coordinates are projected onto three points x on a 2D plane. In order to obtain solutions of this problem, research into a method using quaternions, a Singular Value Decomposition (SVD) method, etc. has been conducted.

At this step, in order to further improve precision, outliers (abnormal points or false information) are eliminated using RANdom SAmple Consensus (RANSAC), and an optimal solution of the current attitude causing a re-projection error to be minimized is found using only inliers (true information) at step S68. As described above, ego-motion information may be obtained from the attitude at step S70. Finally, since the vehicle is a very high mass object, the dynamic behavioral characteristics of the vehicle have low frequency characteristics, so that noise caused by an arithmetic error or the like is eliminated using a Low Pass Filter (LPF), thus obtaining stable ego-motion information at step S72.

Finally, point cloud update step S110 is performed such that, only if the movement of the vehicle above a predetermined amount occurs and the generation of a new key frame is required, bundle adjustment is performed by a separate thread to obtain the key frame at steps S74, S76, and S78.

The bundle adjustment is intended to search for optimal values of camera parameters minimizing an error occurring when the 3D coordinates of feature points are re-projected onto an image and of respective 3D coordinate values. The bundle adjustment searches for the optimal solution of a least square error given in the following equation:

$${min}_{{a}_{j} , {b}_{i}} {\sum }_{i = 1}^{n} {\sum }_{j = 1}^{m} {v}_{ij} {d ( Q ( {a}_{j} , {b}_{j} ) , {x}_{ij} )}^{2}$$

where n denotes the number of 3D points and m denotes the number of images. xᵢⱼ denotes image coordinates of an i-th point in a j-th image, a, denotes the camera parameter of the j-th image, bᵢ denotes 3D coordinates of the i-th point. Q(aⱼ,bᵢ) denotes a predicted projection function of the i-th point in the image j, d(.,.) denotes an error function, and vᵢⱼ denotes a binary value and has a value of 1 when point i appears on the image j, otherwise it has a value of 0. The camera parameter aⱼ includes both internal parameters such as the focal length, distortion, and optical center point of the camera, and external parameters such as the rotation and movement of the camera. In the case of the present invention, the internal parameters of the camera that can be known in advance via the calibration of the camera and the external parameters corresponding to stereoscopic pairs are set to constraint conditions. Further, among the camera parameters aⱼ, only the rotation and movement between frames, and 3D coordinates corresponding to bᵢ are defined as variables, and then a computational load may be reduced.

In order to solve the optimization problem of bundle adjustment, a Levenberg-Marquardt method is mainly used. Since bundle adjustment requires a lot of computations to make it difficult to perform real-time processing, it is performed by threads, and previous values are maintained during the processing of the threads.

A new key frame and a point cloud are applied to images initially obtained after the performance of bundle adjustment has been completed at step S80.

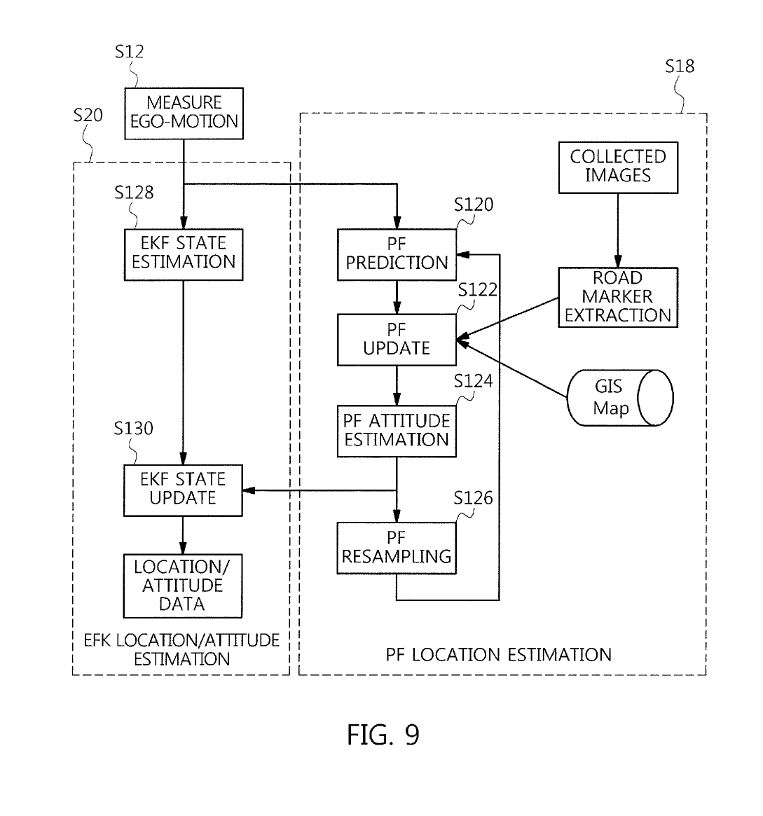

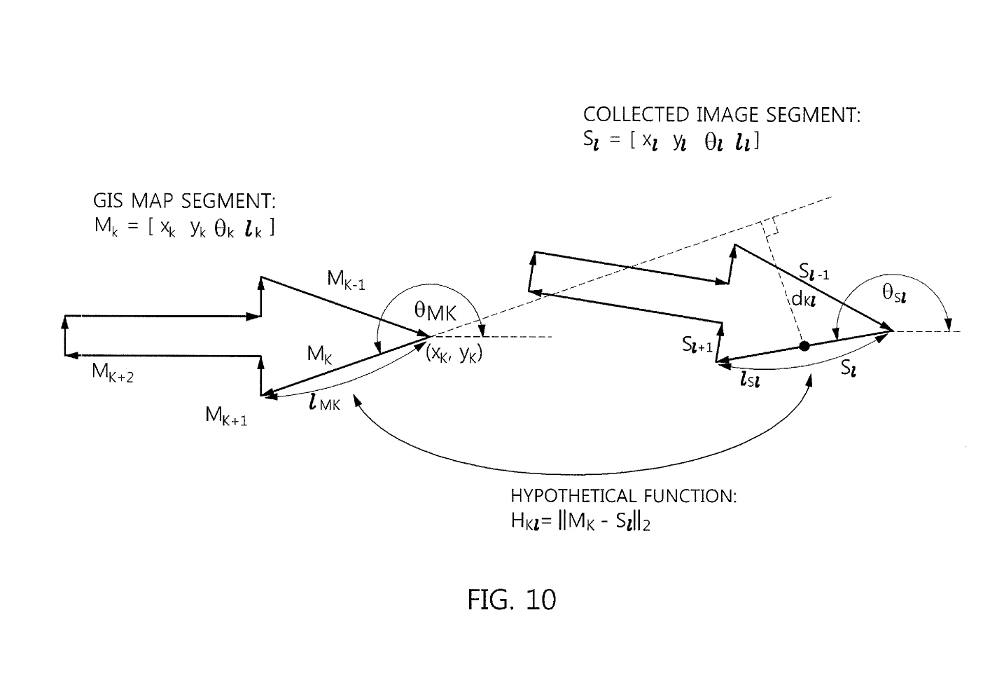

FIG. 9 is a flowchart showing in detail the location/attitude estimation procedure S40 shown in FIG. 5, and FIGS. 10 to 12 are diagrams employed in the description of FIG. 9.

In order for an autonomous driving vehicle to safely move to a desired destination, it is very important to precisely know the absolute location and attitude of the current vehicle. The relative movement displacement and attitude of the vehicle may be derived by accumulating ego-motions (movement) using the above-described image information, but it is impossible to know the absolute location of the vehicle.

In the present invention, in order to solve the above problem, the absolute location and attitude of the vehicle are obtained by combining an Extended Kalman Filter (EKE) with a Particle Filter (PF). The EKF and the PF are techniques well known to the field of location estimation and may also be independently used. The EKF has high precision of state estimation, but is disadvantageous in that robustness thereof is low and it is impossible to estimate a global location. In contrast, the PF is advantageous in that results may be directly derived from input information, robustness is high, and it is possible to estimate a global location, but there is a disadvantage in that precision is relatively low and a lot of computation time is required.

In the present invention, the state of the vehicle is estimated using the EKF at step S128. In this case, the PF estimates the state of the vehicle by comparing a GIS map with image information at steps S120, S122, and S124. The results of the comparison are used as the observed values of the EKF, with the result that the state of the EKF is updated at step S130.

First, at location and attitude estimation step S40, particle filter (PF) location estimation step S18 will be described in detail.

In order to obtain the absolute coordinates of the vehicle on the GIS map, estimation using the PF is performed. The PF is Bayesian sequential importance sampling technology, and is intended to recursively calculate approximate values of posterior distribution using limited weight samples. In other words, this technology is also referred to as a “sequential Monte Carlo method,” and is basically composed of two steps corresponding to prediction and update. If all observable inputs to time t−1 are given as z_{1:t-1}={z₁, . . . , zₜ₋₁}, the prediction step is configured to predict a posterior probability at time t using the stochastic system transition model p(xₜ|xₜ₋₁) by the following equation:

p(xₜ|z_{1:t-1})=∫p(xₜ|xₜ₋₁,uₜ₋₁)p(xₜ₋₁|z_{1:t-1})dxₜ₋₁

where state vector xₜ=[xt yt θt]^{T} denotes particles indicating the location of the vehicle and the attitude of the vehicle in an orthogonal coordinate system, an input vector uₜ denotes the quantity of ego-motion of the vehicle, and an observation vector zₜ denotes observable values. If zₜ is observable at time t, the posterior probability may be updated based on Bayes' rule, as given by the following equation:

$$p ( {x}_{t} \vert {z}_{1 : t} ) = \frac{p ( {z}_{t} \vert {x}_{t} ) p ( {x}_{t} \vert {z}_{1 : t - 1} )}{p ( {z}_{t} \vert {z}_{1 : t - 1} )}$$

where likelihood p(zₜ|xₜ) is defined by an observation equation and may be approximated using weights in the case of the PF. Therefore, the posterior probability p(xₜ|z_{1:t}) may be approximated by N limited samples {xₜⁱ}_{i=1, . . . , N} having a weight of wₜⁱ. If the probability distribution of predicted particles \tilde{x}ₜⁱ is obtained by q(xₜ|x_{1:t-1}, z_{1:t}), the weight thereof is defined by the following equation:

$${w}_{t}^{i} = {w}_{t - 1}^{i} \frac{p ( {z}_{t} \vert {\tilde{x}}_{t}^{i} ) p ( {\tilde{x}}_{t}^{i} \vert {x}_{1 : t - 1}^{i} )}{q ( {\tilde{x}}_{t} \vert {x}_{1 : t - 1} , {z}_{1 : t} )}$$

The particle filter (PF) may directly obtain results from observed values only by calculating the likelihood of input values and observed values, is easily implemented, and has very high robustness. Furthermore, the PF suitably adjusts the number and distribution of particles, and also enables global convergence.

However, precision and an execution speed are increased in proportion to the number of particles. Therefore, since the limited particles must be used, the precision thereof is relatively low. In the present invention, the location of the vehicle is detected from the GIS map using a limited number of particles. Further, the location of the vehicle obtained by the PF is assumed to be a measured value having high noise, and the precise state of the vehicle may be estimated using the EKF. A procedure for estimating the location and the attitude of the vehicle using the PF conforms to the following steps.

1) PF Prediction Step S120

PF prediction step S120 is intended to predict the posterior probabilities of location and attitude of the vehicle where the quantity of ego-motion of the vehicle has been obtained. When an ego-motion vector is defined as uₜ=[δx δy δθ]^{T}, the equation of motion of the vehicle is obtained from the following nonlinear equation:

$$( \begin{matrix}{x}_{t + 1} \\ {y}_{t + 1} \\ {θ}_{t + 1}\end{matrix} ) = ( \begin{matrix}{x}_{t} \\ {y}_{t} \\ {θ}_{t}\end{matrix} ) + ( \begin{matrix}δ x sin ( {θ}_{t} ) - δ y cos ( {θ}_{t} ) \\ δ x cos ( {θ}_{t} ) + δ y sin ( {θ}_{t} ) \\ δθ\end{matrix} ) + {\tilde{w}}_{t}$$

where \tilde{w}ₜ denotes predicted noise and generally conforms to a Gaussian distribution.

2) PF Update Step S122

PF update step S122 is the step of updating an actual posterior probability, wherein, in practice, weights of respective particles obtained via prediction are calculated. In order to calculate those weights, the particles must be observable in respective states. For this, the present invention uses a method of formulating a mapping hypothesis of a map object observable at a current time in a GIS map and an object observed in the image, and confirming the mapping hypothesis.

An observation model used in the present invention is intended to consequently determine the precision of the hypothesis, wherein the observation probability of an i-th particle at time t is defined as follows:

$${p}_{t}^{i} = p ( {z}_{t} \vert {\tilde{x}}_{t}^{i} ) = 1 - \frac{1}{M + N} ( {\sum }_{m = 1}^{M} {F ( {\tilde{x}}_{t}^{i} , {z}_{t} )}_{m} + {\sum }_{n = 1}^{N} {G ( {\tilde{x}}_{t}^{i} , {z}_{t} )}_{n} )$$

where pₜⁱ>1 [symbol] pₜⁱ=1, pₜⁱ<0 [symbol] pₜⁱ=0.

Further, M denotes the number of objects observed in the GIS map, N denotes the number of objects observed in the image, F(·) denotes a map-based observation function F(·)ₘ=min{H(·)ₖₗ|k=m, l=1 . . . N}, and G(·) denotes an image-based observation function G(·)ₙ=min{H(·)ₖₗ|l=n, k=1 . . . M}. H(·) in the observation function is a hypothetical function. In FIG. 10, an example of the hypothetical function is shown.

The hypothetical function H(·)ₖₗ denotes a function of obtaining a probability that k-th data of the GIS map will be mapped to the l-th data of the image data, and is defined by the following equation:

$$\begin{matrix}{H ( x )}_{kl} = {‖ {M ( x )}_{k} - {S ( x )}_{l} ‖}_{2} , & M ( x ) and S ( x ) ∈ W ( {\tilde{x}}_{l}^{i} ) \\ = \sqrt{{d}_{kl}^{2} + {( {μ}_{1} \frac{{θ}_{Mk} - {θ}_{sl}}{π} )}^{2} + {( {μ}_{2} \frac{{l}_{Mk} - {l}_{sl}}{{l}_{Mk}} )}^{2}} , & k = 1 … M , l = 1 … N\end{matrix}$$

where M(x) denotes a function of obtaining the data of a map, S(x) denotes the function of obtaining the data of an image, dₖₗ denotes a distance between the center point of a k-th map vector and the center point of an l-th image vector, θ_{MK} denotes an angle of the k-th map vector, θ_{Sl} denotes an angle of the l-th image vector, l_{Mk} denotes the norm of the k-th map vector, l_{Sl} denotes the norm of the l-th image vector, and μ₁ and μ₂ denote respective constants.

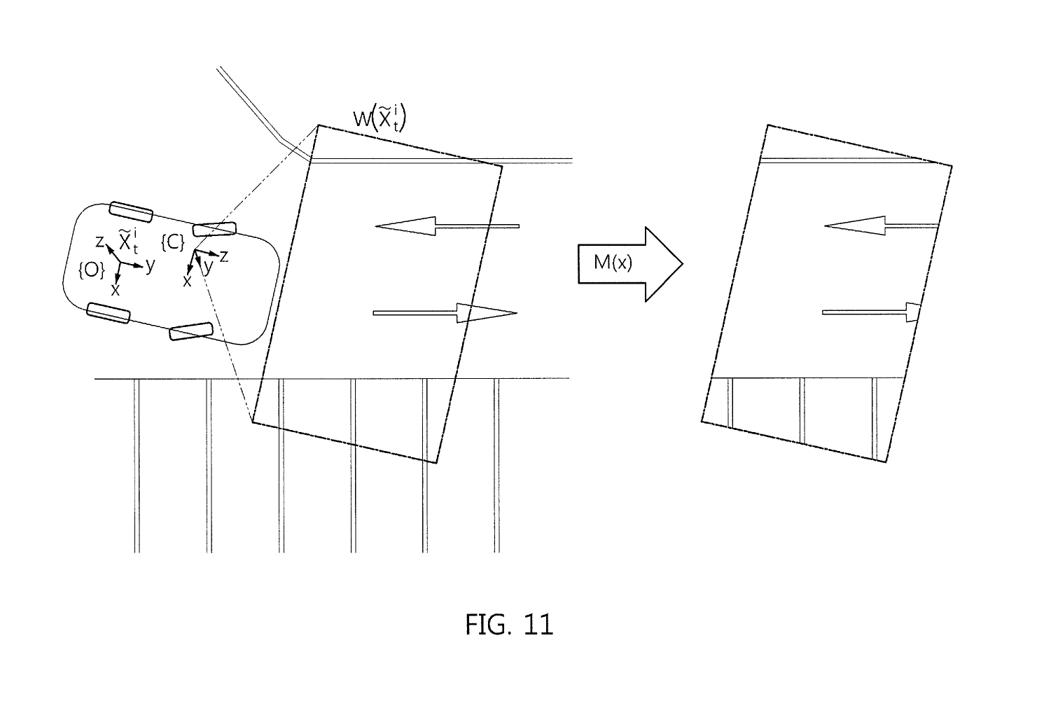

Each piece of object data of the GIS map is a set of vectors having a start point and an end point. The function M(·) extracts only vectors within a projected area W(\tilde{x}ₜⁱ) from the vectors of the GIS map projected at the attitude of the predicted particle \tilde{x}ₜⁱ=[\tilde{x}ₜ \tilde{y}ₜ \tilde{θ}ₜ]^{T}. Depending on the circumstances, a vector forming an intersection with the projected area upon extracting vectors is extracted by changing the intersection to a start point or an end point. The function S(·) denotes a function of extracting markers on the road, and is configured to linearly approximate the projected image to obtain vector data, and transform the vector data into a coordinate system of the GIS map for the attitude of the particle. In this case, in order to eliminate data other than data on the ground surface, all vectors in a previous frame are assumed to be present on the ground surface, and re-projection errors occurring when the vehicle is moved by the quantity of ego-motion are obtained, and thus vectors are removed with the exception of vectors having errors falling within a predetermined range. In this way, all vectors except for vectors actually present on the ground surface may be removed. Finally, pieces of vector data obtained using the functions M(·) and S(·) have only data within the same projection area W(\tilde{x}ₜⁱ) (that is, map data such as that shown in FIG. 11 may be extracted), and thus a direct comparison between the vector data may be performed.

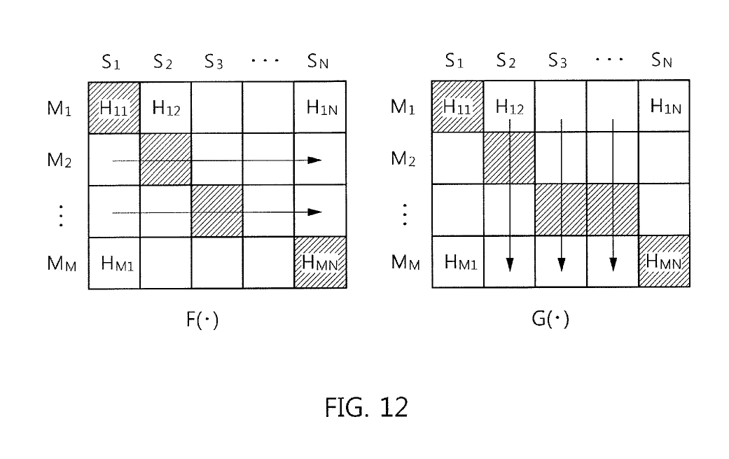

Further, when hypotheses for all cases are formulated from pieces of vector data obtained using the functions M(·) and S(·), a set of hypotheses best suited for the GIS map is F(·), and a set of hypotheses best suited for the image is G(·). When these sets are illustrated in the drawings, FIG. 12 may be referred to.

If the observation probabilities of all particles have been obtained, weights of the respective particles are obtained from the observation probabilities. The weights of the particles are obtained by normalizing the respective observation probabilities, as given by the following equation:

$${w}_{t}^{i} = \frac{{p}_{l}^{i}}{{\sum }_{k = 1}^{N} {p}_{t}^{k}}$$

where N denotes the total number of particles, pₜⁱ denotes the observation probability of an i-th particle at time t, and pₜ^{k} denotes the observation probability of a k-th particle at the time t.

3) PF Attitude Estimation Step S124

If the prediction and update of each particle have been completed, a new state may be estimated from the prediction and update results. This new state xₑₛₜ=[\hat{x} ŷ \hat{θ}]^{T} may be the finally estimated location and attitude of the vehicle. That is,

$${x}_{est} = {\sum }_{i = 1}^{N} {w}_{t}^{i} {\tilde{x}}_{t}^{i}$$

is obtained.

4) PF Resampling Step S126

At PF resampling (re-extraction) step S126, particles to be used in a subsequent frame are newly generated based on weights. The newly generated particles are obtained in proportion to the respective weights, and inherit the attributes of previous particles without change. In this case, when the maximum value pₘₐₓ=max{pₜⁱ|i=1 . . . N} of the observation probabilities of the particles is less than or equal to a threshold value τₚ, it may be considered than the reliability of an estimated vehicle state is low. In this case, a particle having a predicted result value obtained by the Extended Kalman Filter (EKF) as an attribute is additionally generated, and thus reliability in a subsequent step may be improved.

Below, EKF state estimation step S128 at EKF location/attitude estimation step S20 shown in FIG. 9 will be described in detail.

A Kalman filter is a recursive filter for estimating the state of a linear system including noise and has been widely used in various fields. An EKF is an extended version of the nonlinear system of the Kalman filter. The above-described Particle Filter (PF) has high robustness, but has low precision. Since the results of state estimation having low precision may be regarded as containing high noise, the precision of state estimation may be improved by exploiting the EKF. The Kalman filter uses two steps corresponding to prediction and update steps. Since the Kalman filter is a well-known predictor, a detailed description thereof will be omitted.

In order to estimate the location and attribute of the vehicle, when a state vector is defined as xₖ=[x y θ]^{T}, and an input vector is defined as uₖ=[δx δy δθ]^{T}, a nonlinear state equation for the motion of the vehicle is defined by the following equation:

$${x}_{k + 1} = [ \begin{matrix}1 & 0 & 0 \\ 0 & 1 & 0 \\ 0 & 0 & 1\end{matrix} ] {x}_{k} + [ \begin{matrix}sin ( {θ}_{k} ) & - cos ( {θ}_{k} ) & 0 \\ cos ( {θ}_{k} ) & sin ( {θ}_{k} ) & 0 \\ 0 & 0 & 1\end{matrix} ] {u}_{k}$$

$${y}_{k} = [ \begin{matrix}1 & 0 & 0 \\ 0 & 1 & 0 \\ 0 & 0 & 1\end{matrix} ] {x}_{k}$$

The input vector uₖ=[δx δy δθ]^{T} is received from the estimation results of the ego-motion of the vehicle to perform the prediction step, and an observed value \hat{z}ₖ=xₑₛₜ=[\hat{x} ŷ \hat{θ}]^{T} obtained from the results of the PF is received to perform the update step, and thus the estimation of the state using the EKF is completed.

Meanwhile, the real-time prediction procedure S50 will be described in detail. The results of the vehicle state estimated at the steps of FIGS. 8 and 9 correspond to results at previously elapsed time from the standpoint of generation time. Furthermore, since the PF has a highly variable computation time, a time at which the results of the PF are derived is also variable. In the present invention, in order to solve this problem, the dynamic characteristics of the vehicle are estimated using a linear Kalman filter and then the state of the vehicle at a required time is predicted.

If the state vector of the dynamics model of the vehicle is defined as xₖ=[x \dot{x} \ddot{x} y \dot{y} ÿ θ\dot{θ} \ddot{θ}]^{T}, an input vector is defined as uₖ=[δx δy δθ]^{T}, and an output vector is defined as yₖ=[x y θ]^{T}, and if the vehicle is modeled as being linearly and uniformly accelerated, a state equation for the dynamics model of the vehicle may be defined by the following equation:

xₖ₊₁=Axₖ+Buₖ

yₖ₊₁=Cxₖ

In this case, a system matrix is given as follows:

$$A = [ \begin{matrix}1 & Δ t & Δ {t}^{2} / 2 & 0 & 0 & 0 & 0 & 0 & 0 \\ 0 & 1 & Δ t & 0 & 0 & 0 & 0 & 0 & 0 \\ 0 & - 1 / Δ t & 1 & 0 & 0 & 0 & 0 & 0 & 0 \\ 0 & 0 & 0 & 1 & Δ t & Δ {t}^{2} / 2 & 0 & 0 & 0 \\ 0 & 0 & 0 & 0 & 1 & Δ t & 0 & 0 & 0 \\ 0 & 0 & 0 & 0 & - 1 / Δ t & 1 & 0 & 0 & 0 \\ 0 & 0 & 0 & 0 & 0 & 0 & 1 & Δ t & Δ {t}^{2} / 2 \\ 0 & 0 & 0 & 0 & 0 & 0 & 0 & 1 & Δ t \\ 0 & 0 & 0 & 0 & 0 & 0 & 0 & - 1 / Δ t & 1\end{matrix} ]$$

$$B = [ \begin{matrix}0 & 0 & 0 \\ 0 & 0 & 0 \\ 1 / Δ {t}^{2} & 0 & 0 \\ 0 & 0 & 0 \\ 0 & 0 & 0 \\ 0 & 1 / Δ {t}^{2} & 0 \\ 0 & 0 & 0 \\ 0 & 0 & 0 \\ 0 & 0 & 1 / Δ {t}^{2}\end{matrix} ]$$

$$C = [ \begin{matrix}1 & 0 & 0 & 0 & 0 & 0 & 0 & 0 & 0 \\ 0 & 0 & 0 & 1 & 0 & 0 & 0 & 0 & 0 \\ 0 & 0 & 0 & 0 & 0 & 0 & 1 & 0 & 0\end{matrix} ]$$

where Δt denotes a unit time.

The input vector of the linear Kalman filter uses an estimated value for the ego-motion of the vehicle, and an observation vector uses the output of the EKF. If the state of the vehicle dynamics model is estimated using the linear Kalman filter, the state of the vehicle after the elapse of an arbitrary time δt may be predicted as follows.

$${\tilde{x}}_{k + δ t} = {x}_{k} + {\dot{x}}_{k} δ t + \frac{1}{2} {\ddot{x}}_{k} δ {t}^{2}$$

$${\tilde{y}}_{k + δ t} = {y}_{k} + {\dot{y}}_{k} δ t + \frac{1}{2} {\ddot{y}}_{k} δ {t}^{2}$$

$${\tilde{θ}}_{k + δ t} = {θ}_{k} + {\dot{θ}}_{k} δ t + \frac{1}{2} {\ddot{θ}}_{k} δ {t}^{2}$$

The prediction of the location and attitude of the vehicle using the above method not only can solve the problem of the timing of information occurring upon estimating and computing information, but also can provide information about any time at which the vehicle control unit 70 requests information, thus enabling the problem of synchronization with the vehicle control unit 70 upon providing information to be easily solved.

In this case, since the heading angle θₕ of the vehicle is an angle in a clockwise direction based on a due north direction, and the predicted attitude \tilde{θ}ₖ of the vehicle obtained from a map coordinate system is an angle in the orthogonal coordinate system, it should be noted that the following relationship is established.

$${θ}_{h} = - ( {\tilde{θ}}_{k} - \frac{1}{2} π ) , ∀ {θ}_{h} [ 0 , 2 π ]$$

The above-described results are obtained based on the orthogonal coordinate system on a GIS map. At this step, if necessary, the coordinate system may be transformed into requested latitude/longitude coordinate systems or the like, and then transformed results may be provided.

In accordance with the present invention having the above configuration, an autonomous driving vehicle may travel on a road within a complicated housing complex using only standardized GIS maps and image information without using expensive equipment such as existing GPS/INS equipment or a laser scanner.

Standardized GIS maps used in the present invention not only can be easily created and managed, but also are very useful and practical compared to large-capacity accurate maps used by existing autonomous driving vehicles because information can be shared among pieces of heterogeneous equipment. Further, those maps may be managed by respective institutions, thus guaranteeing the reliability of the maps.

Furthermore, since the present invention uses only an inexpensive image sensor as the input sensor of the system, the construction cost of the system can be remarkably reduced, thus greatly contributing to the popularization of autonomous driving vehicles in the future.

Furthermore, the present invention can provide a robust vehicle state estimation method and can predict the state of a vehicle at any time using image information and GIS map information, thereby greatly improving real-time properties and usefulness upon providing the state information of the vehicle. This means that continuous information at any time, rather than binary information at the moment at which images are collected, can be provided without causing a time delay.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. An apparatus for providing location and heading information of an autonomous driving vehicle on a road within a housing complex, comprising:
an image sensor installed on an autonomous driving vehicle and configured to detect images of surroundings depending on motion of the autonomous driving vehicle;
a wireless communication unit installed on the autonomous driving vehicle and configured to receive a Geographic Information System (GIS) map of inside of a housing complex transmitted from an in-housing complex management device in a wireless manner; and
a location/heading recognition unit installed on the autonomous driving vehicle, and configured to recognize location and heading of the autonomous driving vehicle based on the image information received from the image sensor and the GIS map of the inside of the housing complex received via the wireless communication unit.

2. The apparatus of claim 1, wherein the location/heading recognition unit estimates ego-motion from stereoscopic images, acquired by the image sensor, using a multi-view image processing technique, converts the images collected by the image sensor into images projected onto a ground surface of the road to extract markers on the road, obtains a probability of matching the GIS map to estimate a current location and attitude, and estimates a dynamic behavioral state of the vehicle based on the estimated ego-motion and the estimated current location and attitude to output predicted results of a state of the vehicle.

3. The apparatus of claim 2, wherein the location/heading recognition unit is configured to:
define three-dimensional (3D) coordinates of feature points detected from an image initially acquired by the image sensor as initial values of a point cloud, and
track feature points acquired from a previous key frame on an image plane whenever each image is input from the image sensor, obtain relative coordinates at a current time based on a key frame using a Perspective-Three-Point (P3P) technique, and calculate the ego-motion from relative coordinates of the previous key frame and relative coordinates at the current time.

4. The apparatus of claim 3, wherein the location/heading recognition unit is configured such that, when movement of the autonomous driving vehicle above a predetermined amount occurs, and generation of a new key frame is required, a separate thread performs bundle adjustment and then updates the point cloud.

5. The apparatus of claim 2, wherein the location/heading recognition unit uses a combination of a Particle Filter (PF) with an Extended Kalman Filter (EKF) to compare each projected image with the GIS map.

6. The apparatus of claim 2, wherein the location/heading recognition unit uses a linear Kalman filter upon estimating the dynamic behavioral state of the corresponding vehicle.

7. The apparatus of claim 1, wherein the wireless communication unit additionally receives path information including a recommended path from the in-housing complex management device, and transmits the path information to the location/heading recognition unit.

8. The apparatus of claim 7, wherein the recommended path includes a path along which the vehicle arrives at a destination, and a path along which the vehicle departs from the housing complex.

9. The apparatus of claim 1, wherein the wireless communication unit additionally receives auxiliary information with respect to interference with safe driving of the autonomous driving vehicle from the in-housing complex management device, and transmits the auxiliary information to the location/heading recognition unit.

10. The apparatus of claim 1, wherein the image sensor includes a plurality of sensors.

11. A system for providing location and heading information of an autonomous driving vehicle on a road within a housing complex, comprising:
an in-housing complex management device including an environment monitoring sensor for monitoring entry of an approved vehicle into a housing complex, and a management server for, as the entry of the approved vehicle into the housing complex is monitored by the environment monitoring sensor, generating a GIS map of inside of the housing complex and transmitting the GIS map to an in-autonomous driving vehicle device in a wireless manner; and
the in-autonomous driving vehicle device including an image sensor for detecting images of surroundings depending on motion of the autonomous driving vehicle, and a location/heading recognition unit for recognizing location and heading of the autonomous driving vehicle, based on the GIS map of the inside of the housing complex transmitted in a wireless manner from the in-housing complex management device and image information transmitted from the image sensor.

12. A method for providing location and heading information of an autonomous driving vehicle on a road within a housing complex, comprising:
detecting, by an image sensor installed on an autonomous driving vehicle, images of surroundings depending on motion of the autonomous driving vehicle;
receiving, by a wireless communication unit installed on the autonomous driving vehicle, a Geographic Information System (GIS) map of inside of the housing complex transmitted from an in-housing complex management device in a wireless manner; and
recognizing, by a location/heading recognition unit installed on the autonomous driving vehicle, location and heading of the autonomous driving vehicle based on image information about the detected images and the received GIS map of the inside of the housing complex.

13. The method of claim 12, wherein recognizing the location and heading of the autonomous driving vehicle comprises:
estimating ego-motion from stereoscopic images acquired by the image sensor, using a multi-view image processing technique;
extracting markers on the road by converting the images collected by the image sensor into images projected onto a ground surface of the road, and estimating a current location and attitude by obtaining a probability of matching the GIS map; and
estimating a dynamic behavioral state of the vehicle based on the estimated ego-motion and the estimated current location and attitude and then outputting predicted results of a state of the vehicle.

14. The method of claim 13, wherein estimating the ego-motion comprises:
defining three-dimensional (3D) coordinates of feature points detected from an image initially acquired by the image sensor as initial values of a point cloud;
tracking feature points acquired from a previous key frame on an image plane whenever each image is input from the image sensor, obtaining relative coordinates at a current time based on a key frame using a Perspective-Three-Point (P3P) technique, and calculating the ego-motion from relative coordinates of the previous key frame and relative coordinates at the current time; and
when movement of the autonomous driving vehicle above a predetermined amount occurs, and generation of a new key frame is required, performing bundle adjustment in a separate thread and then updating the point cloud.

15. The method of claim 13, wherein estimating the current location and attitude is configured to use a combination of a Particle Filter (PF) with an Extended Kalman Filter (EKF) to compare each projected image with the GIS map.

16. The method of claim 13, wherein estimating the current location and attitude comprises:
predicting posterior probabilities of a location and an attitude at which a quantity of ego-motion of the corresponding vehicle has been obtained;
obtaining weights of respective particles obtained via the prediction, and then updating the posterior probabilities; and
estimating the location and attitude of the vehicle based on predicted and updated results.

17. The method of claim 13, wherein outputting the predicted results is configured to use a linear Kalman filter upon estimating the dynamic behavioral state of the corresponding vehicle.

18. The method of claim 12, wherein receiving the GIS map comprises additionally receiving path information including a recommended path from the in-housing complex management device.

19. The method of claim 18, wherein the recommended path includes a path along which the vehicle arrives at a destination, and a path along which the vehicle departs from the housing complex.

20. The method of claim 12, wherein receiving the GIS map comprises additionally receiving auxiliary information with respect to interference with safe driving of the autonomous driving vehicle from the in-housing complex management device.
